(19) United States
(12) Patent Application Publication
(10) Pub. No.: US 2008/0300888 A1
(43) Pub. Date: Dec. 4, 2008

(54) Systems and Methods for Providing Risk Methodologies for Performing Supplier Design for Reliability

(75) Inventors: Michael J. Dell'Anno, Clifton Park, NY (US); Ronald Paul Wiederhold, Waterford, NY (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/755,510

(22) Filed: May 30, 2007

(51) Int. Cl. G06Q 99/00

(52) U.S. Cl. 705/1

(57) ABSTRACT

Embodiments of the invention can provide systems and methods for providing risk methodologies for performing supplier design for reliability. According to one embodiment of the invention, a method for analyzing reliability associated with a product provided by a supplier can be provided. The method can include providing a supplier a specification for a product, wherein the specification is based at least in part on an amount of risk to be associated with the product. In addition, the method can include requesting the supplier to perform at least one task to analyze reliability associated with the product in accordance with the specification. Furthermore, the method can include obtaining an output associated with the reliability from the supplier. Furthermore, the method can include comparing the output to the specification for the product. In addition, the method can include based at least in part on the comparison, approving or disapproving of the product.

### FIELD OF THE INVENTION

The invention relates to quality improvement systems and processes, and more particularly, to systems and methods for providing risk methodologies for performing supplier design for reliability.

### BACKGROUND OF THE INVENTION

Supplier, original equipment manufacturer (OEM), and original equipment designer (OED) reliability problems can be prevalent across many industries. When a supplier, OEM or OED experiences a problem with equipment reliability, for instance, the reliability problem can impact their project delivery time and schedule. Corrective actions taken to repair or fix these problems can result in delays to their customer's delivery times and schedules, and may result in additional expenses, such as warranty expenses. Ultimately, these delays can increase costs to the supplier, OEM, OED, their customers, and their customer's customers.

Furthermore, if products are sold or distributed to customers with the problems left unresolved or uncorrected, the existence of these problems can expose customers to unnecessary safety risks.

Thus, there is a need for systems and methods for providing risk methodologies for performing supplier design for reliability.

### BRIEF DESCRIPTION OF THE INVENTION

Embodiments of the invention can address some or all of the needs described above. Embodiments of the invention are directed generally to systems and methods for providing risk methodologies for performing supplier design for reliability. According to one embodiment of the invention, a method for analyzing reliability associated with a product provided by a supplier can be provided. The method can include providing a supplier a specification for a product, wherein the specification is based at least in part on an amount of risk to be associated with the product. In addition, the method can include requesting the supplier to perform at least one task to analyze reliability associated with the product in accordance with the specification. Furthermore, the method can include obtaining an output associated with the reliability from the supplier. Furthermore, the method can include comparing the output to the specification for the product. In addition, the method can include based at least in part on the comparison, approving or disapproving of the product.

According to another embodiment of the invention, a method for analyzing reliability associated with a product can be provided. The method can include receiving a specification associated with a product, wherein the specification is based at least in part on an amount of risk to be associated with the product. In addition, the method can include performing at least one task to analyze reliability associated with the product to a customer in accordance with at least a portion of the specification. Furthermore, the method can include providing an output associated with the reliability to the customer. Furthermore, the method can include based at least in part on a comparison of the output to a portion of the specification associated with the product, receiving an approval or disapproval of the product from the customer.

According to yet another embodiment of the invention, a system for analyzing reliability of a product provided by a supplier can be provided. The system can include a reliability module adapted to provide a supplier a specification for a product, wherein the specification is based at least in part on an amount of risk to be associated with the product. In addition, the module can be adapted to a request the supplier to perform at least one task to analyze reliability associated with the product in accordance with the specification. Furthermore, the module can be adapted to obtain an output associated with the reliability from the supplier. Moreover, the module can be adapted to compare the output to the specification for the product. Further, the module can be adapted to, based at least in part on the comparison, approve or disapprove of the product.

According to yet another embodiment of the invention, a system for analyzing reliability associated with a product can be provided. The system can include a reliability module adapted to receive a specification associated with a product, wherein the specification is based at least in part on an amount of risk to be associated with the product. In addition, the reliability module can be adapted to facilitate performing at least one task to analyze reliability associated with the product to a customer in accordance with at least a portion of the specification. Furthermore, the reliability module can be adapted to provide an output associated with the reliability to the customer. Moreover, the reliability module can be adapted to, based at least in part on a comparison of the output to a portion of the specification associated with the product, receive an approval or disapproval of the product from the customer.

Other embodiments and aspects of the invention will become apparent from the following description taken in conjunction with the following drawings.

### BRIEF DESCRIPTION OF THE DRAWINGS

Having thus described the invention in general terms, reference will now be made to the accompanying drawings, which are not necessarily drawn to scale, and wherein:

FIG. 1 is a flowchart illustrating an example method for analyzing reliability associated with a product according to one embodiment of the invention.

FIG. 2 illustrates an example chart for determining a series of one or more reliability tasks based at least in part on an amount of risk for the product to be supplied according to one embodiment of the invention.

FIG. 3 illustrates an example chart for providing a failure mode and effects analysis (FMEA) according to one embodiment of the invention.

FIG. 4 illustrates examples of several failure rate prediction methods according to one embodiment of the invention.

FIG. 5 illustrates a chart with several example failure rate model types which can be used for a physics based model depending on the technology type according to one embodiment of the invention.

FIG. 6 illustrates an example chart with three types of failure rate distribution types according to one embodiment of the invention.

FIG. 7 illustrates an example equation for determining a mean time to repair according to one embodiment of the invention.

FIG. 8 illustrates an example process flow for a HALT test according to one embodiment of the invention.

FIG. 9 illustrates an example system for analyzing reliability of a product provided by a supplier according to one embodiment of the invention.

### DETAILED DESCRIPTION OF THE INVENTION

The invention now will be described more fully hereinafter with reference to the accompanying drawings, in which example embodiments of the invention are shown. This invention may, however, be embodied in many different forms and should not be construed as limited to the example embodiments set forth herein; rather, these embodiments are provided so that this disclosure will convey the scope of the invention to those skilled in the art. Like numbers refer to like elements throughout.

Embodiments of the invention are described below with reference to block diagrams and schematic illustrations of methods and systems according to embodiments of the invention. It will be understood that each block of the diagrams, and combinations of blocks in the diagrams can be implemented by computer program instructions. These computer program instructions may be loaded onto one or more general purpose computers, special purpose computers, or other programmable data processing apparatus to produce machines, such that the instructions which execute on the computers or other programmable data processing apparatus create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

Embodiments of the invention can be implemented within a quality improvement process and system. In one embodiment, a method for determining the level of reliability analysis to be performed by a particular supplier during the design of a product to be supplied can be implemented. In this embodiment, various business and safety risks can be used in the reliability analysis. The method can provide guidance to the supplier on how to design a reliable product. In other embodiments, a supplier can be an OEM (original equipment manufacturer) or OED (original equipment designer). In yet other embodiments, a product can be any type of item or manufactured good, sub-product, sub-component, component, sub-system, or system.

An example of an implementation of a method in accordance with an embodiment of the invention can be used with the design of a supplier, OEM, OLD, or other vendor-provided product or product component. A customer can require the use of a reliability improvement method by some or all suppliers, OEMs, and OEDs involved with the manufacture of the product. The customer can utilize a series of predefined business and safety risk levels to assign an appropriate reliability analysis to the design process of each supplier, OEM, or OED to ensure a certain level of reliability can be achieved. In this manner, the reliability, and in some instances, the safety of products provided by each supplier, OEM, or OED can be improved.

For example, a customer can require a supplier, OEM, or OED to perform such functions as reviewing past failure history for similar products, performing failure mode and effect analyses (FMEA) to predict new types of failure mechanisms, study stresses on a product and product components, and perform reliability testing. When some or all of these activities are complete, some or all of the results can be incorporated into the product design to improve product reliability.

This embodiment of the methodology has at least two features: (1) The methodology permits for different levels of reliability analysis rigor to be applied during the design of a product or product components. This can optimize time spent performing reliability analyses, which may ultimately reduce the business and/or safety risks that may be associated with the product, and may also reduce the number of reliability analysis tasks which may be required to be performed. Therefore, there is a corresponding reduction in the amount of analysis on products or components that may expose a business to low risk in the event of failure, which can result in increased productivity. A second feature is that: (2) The methodology provides guidance on how to economically and effectively perform a reliability analysis aimed at ensuring that a predefined level of reliability is met. Since the supplier, OEM, or OED can perform reliability tasks during design processes, some or all of these tasks are designed to expose failure mechanisms of the product or product components when they are being designed.

In use, embodiments of the invention can be utilized to increase supplier, OEM, and OED equipment reliability and robustness for their products. In turn, a customer can increase its product reliability and robustness. Increased reliability and robustness can improve operating times for the products, and avoid nuisance costs such as a warranty expenses, and potential safety costs and risks.

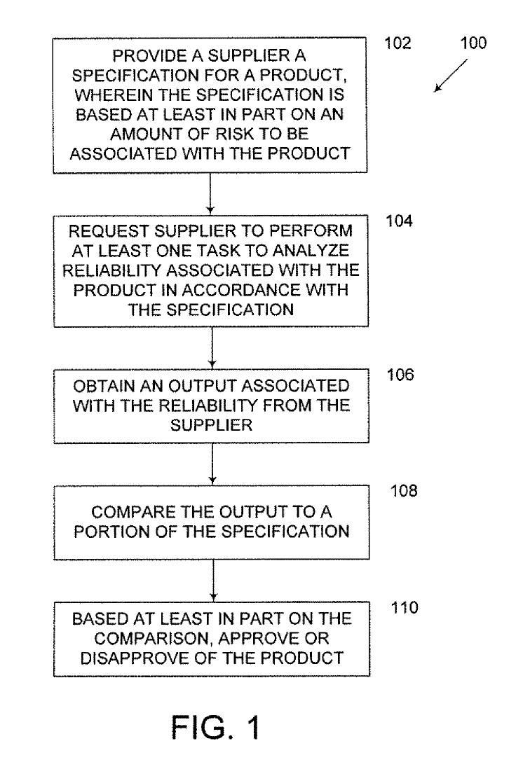

Reliability Methodology. An example method 100 for analyzing reliability associated with a product is shown in FIG. 1. The example method 100 shown is a method for analyzing the reliability of a product provided by a supplier of the product. The method can be, for example, implemented by a system 900 described and shown in FIG. 9.

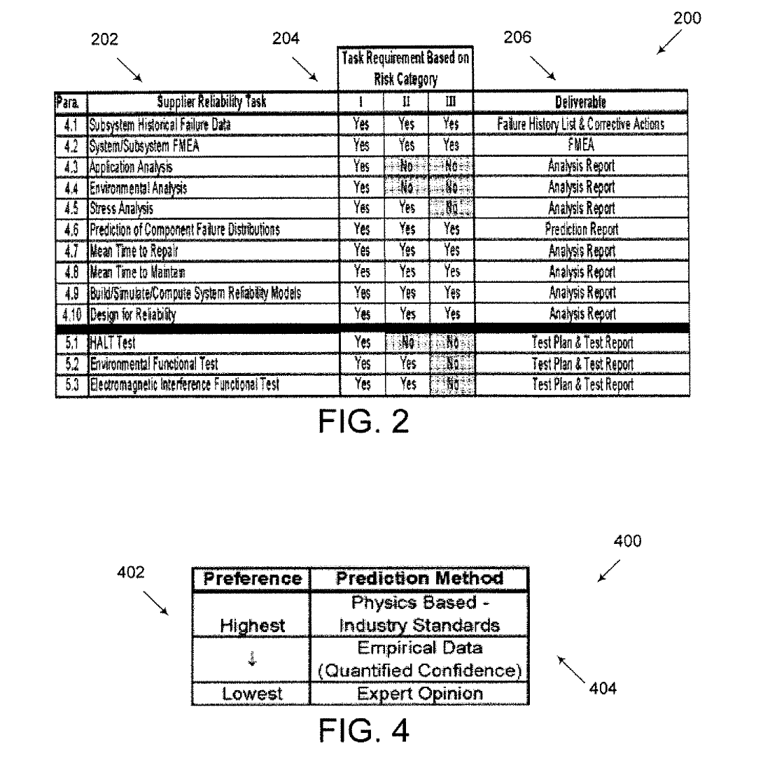

The method 100 begins at block 102. In block 102, a supplier is provided a specification for a product. For example, a specification for a product can be a product functional specification for manufacturing the product, wherein the specification is based at least in part on an amount of risk to be associated with the product. By way of further example, amounts of risk to be associated with a product can be defined as described with respect to FIG. 2. In another embodiment, a specification for a service can be used, such as a service functional specification for a service, wherein the specification is based at least in part on an amount of risk. A “specification” can be defined as a list of tasks, requirement, contract, purchase order, statement of work, or any other device or means for communicating a requirement between businesses, entities, persons, or any combination thereof.

Block 102 is followed by block 104, in which the supplier is requested to perform at least one task to analyze reliability associated with the product in accordance with the specification. For example, a series of tasks can be provided to a supplier. A task can be associated with analyzing reliability in the product or a component of the product. Some or all of the tasks can be based at least in part on the relative amount of reliability risk to be taken for the product to be designed. That is, if a user wants a relatively small amount of reliability risk to be associated with the product, then additional tasks can be performed. Likewise, if a user wants a relatively greater amount of reliability risk to be associated with the product, then fewer tasks can be performed.

Block 104 is followed by block 106, in which an output associated with the reliability is obtained from the supplier. For example, after the supplier has performed some or all of the tasks, the supplier can generate an output such as a report.

Block 106 is followed by block 108, in which the output is compared to the specification for the product. For example, a comparison of at least a portion of the output with the product functional specification for manufacturing the product can be performed.

Block 108 is followed by block 110, in which based at least in part on the comparison, the product can be approved or disapproved. For example, using the comparison to the product functional specification a decision to approve or disapprove of the product can be made. As needed, some or all of the steps in the method 100 can be repeated until some or all of the specifications for the product are met, or until no further improvements in the reliability or product can be achieved.

The method 100 ends at block 110.

In other embodiments, an example method for analyzing reliability of a product can have fewer or greater numbers of steps, and the steps may be performed in an alternative order. It will be understood by those skilled in the art that the embodiments described herein may be applicable to a variety of circumstances, including supply chains, different customer-supplier relationships, other types and combinations of chains or relationships, should not limited to the relationships or products described by this specification.

Reliability Tasks. FIG. 2 illustrates an example chart 200 for determining a series of one or more reliability tasks based at least in part on an amount of risk for the product to be supplied. Various tasks, such as reliability tasks 202 specified in the chart 200, can define one or more activities for suppliers and sub-suppliers to attain a specification, such as a set of reliability design requirements, during the design, manufacture, and distribution of a product or product component. Some or all of the reliability tasks 202 are intended to address reliability in a product by identifying, quantifying, and mitigating some or all known or subsequently identified failure modes and mechanisms. The various reliability tasks 202 described in FIG. 2 can be performed in any particular order than the order shown.

Examples of tasks and reliability tasks can include, but are not limited to, obtaining or determining subsystem historical failure data, obtaining or determining system/sub-system failure modes and effects analysis, obtaining or conducting an application analysis, obtaining or conducting an environmental analysis, obtaining or conducting a stress analysis, obtaining or determining a prediction of component failure distributions, obtaining or determining a mean time to repair, obtaining or determining a mean time to maintain, obtaining or determining a reliability model, designing for reliability, obtaining or conducting a (HALT) test, obtaining or conducting an environmental functional test, and obtaining or conducting an electromagnetic interference functional test. Other tasks can exist with other embodiments of the invention, and some or all of the tasks described above can be modified depending on the type of product, product component, supplier, or customer.

Identifying Product Specifications. In general, a product or product component can be defined by at least one specification or other requirement. Typically, a customer can provide or otherwise identify a specification or requirement for a product or product component to be designed, manufactured, or otherwise provided. A specification associated with a product or product component can include, but is not limited to, a product functional specification, a physical characteristic, a functional characteristic, an electrical property, a mechanical property, a chemical property, an electromechanical property, an ornamental feature, a dimension, or any product feature which can detected or measured by a customer. Other specifications or requirements can exist with other embodiments of the invention, and some or all of the specifications or requirements described above can be modified depending on the type of product, product component, supplier, or customer.

Examples of product specifications or requirements can include, but are not limited to, military specifications, electromechanical specifications, electrical specifications, and interconnection and packaging specifications. Particular examples of a product specification can include, but are not limited to, the following:

### US Military:

| | |
|---|---|
| MIL-HDBK-217F | Reliability Prediction of Electronic Equipment |
| MIL-HDBK-338B | Electronic Reliability Design Handbook |
| MIL-STD-461 | Control of Electromagnetic Interference |
| MIL-HDBK-472 | Maintainability Prediction |
| MIL-STD-785 | Reliability Modeling and Prediction |
| MIL-STD-810 | Environmental Test Methods |
| MIL-STD-1629 | Procedures for Performing a Failure Mode |
| | Effects Analysis |
| NSWC-98/LE1 | Handbook of Reliability Predictions - Mechanical |
| | Equipment |

### IEC—International Electromechanically Commission:

| | |
|---|---|
| IEC 60300 | Dependability (Reliability) Management |
| IEC 60605 | Equipment Reliability Testing |
| IEC 60706 | Guide on Maintainability of Equipment |
| IEC 60812 | Analysis Techniques for System Reliability FMEA |
| | Procedure |
| IEC 61078 | Dependability Analysis - Reliability Block Diagrams |
| IEC 61163 | Reliability Stress Screening |
| IEC 61709 | Electronic Components - Reliability - Reference Conditions |
| | For Failure Rates and Stress Models for Conversion |
| IEC 60068 | Environmental Testing |
| IEC 61000 | Electromagnetic Compatibility |

### IPC—Institute for Interconnecting and Packaging:

| | |
|---|---|
| IPC-SM-785 | Guidelines for Accelerated Reliability Testing of Surface |
| | Mount Solder Attachments |

### IEEE—Institute of Electrical and Electronics Engineers:

| | |
|---|---|
| IEEE-500 | Reliability Data of Electronic, Sensing Component, and |
| | Mechanical Equip Data for Nuclear Generating Stations |

Various risk categories can be defined depending on one or more product or service specifications. In general, a product or service specification can define a risk category and any modifications to one or more reliability tasks specified within the specification. For example, each of the tasks 202 in FIG. 2 can be based at least in part on one or more product or service specifications which specify quantitative reliability and maintainability requirements as well as specified risk category requirements.

In the embodiment shown in FIG. 2, at least one of a series of three risk categories 204, I, II, or III, can be selected for a particular product to be designed or provided by a supplier. Each of the risk categories can be associated with a varying degree of risk, for instance, risk category “I” can be associated with a relatively low amount of risk, risk category “II” can be associated with an intermediate amount of risk, and risk category “III” can be associated with a relatively high amount of risk. In other embodiments of the invention, other relative levels and categories of risk can exist.

Referring to FIG. 2, if for example, risk category “I” is selected for a product, then each reliability task 202 can be performed depending on the corresponding “Yes” and “No” in the adjacent risk category columns 204. If the reliability task 202 is to be performed based on the selected risk category, indicated by a “Yes” in risk category column 204, then the supplier will be required to perform that task when designing the product. Alternatively, if the reliability task 202 is not to be performed based on the selected risk category, indicated by a “No” in risk category column 204, then the supplier does not have to perform that task to satisfy the risk category when designing the product. Thus, selection of a particular risk category can determine a series of tasks for a particular product.

In one embodiment, a supplier can propose alternative reliability tasks, risk categories, and process methods to satisfy the intent of the requirements associated with or otherwise imposed by product specifications. In these embodiments, suppliers can submit analysis, data, and test results of similar products to satisfy these requirements for approval.

Associated with each reliability task, for example 202 in FIG. 2, is at least one output or deliverable 206. After a supplier has implemented or otherwise completed a respective task, an output or deliverable can be provided for each task. Examples of an output or deliverable can include, but are not limited to, a list, a report, a plan, an analysis, a prediction, an indicator, a failure history list, a corrective action list, a failure mode and effects analysis, an analysis report, a prediction report, a test plan, a test report, or any other similar output associated with providing improvement advice or data to an entity. In one embodiment, an output can be a signal, such as a signal transmitted via a network, associated with at least one of the examples described above. Other types of output can exist with other embodiments of the invention, and some or all of the outputs described above can be modified depending on the type of product, product component, reliability task, supplier, or customer.

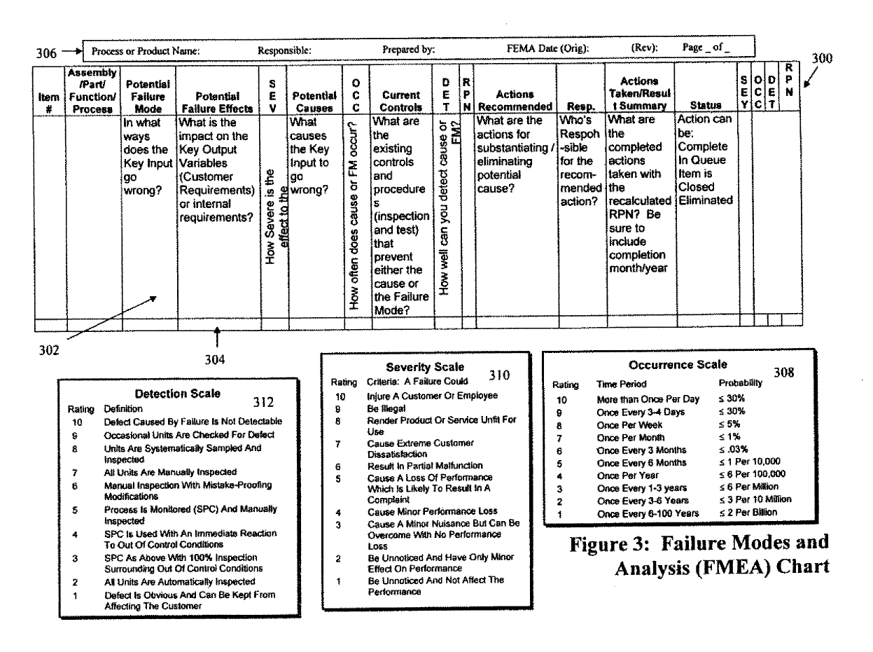

As discussed above with respect to selecting the various tasks 202 in FIG. 2, in at least one embodiment, reliability tasks can be dependent on the desired level of reliability analysis for a product to be designed, manufactured, or otherwise provided. In general, reliability analysis can be a cost effective means to assess the reliability of a product and minimize or eliminate failure modes before one or more prototypes are built for test. This type of analysis can enable a relatively more robust product to be built the first time while eliminating or otherwise reducing costly and time consuming prototype iterations. Reliability analysis can also enable an effective means of trade-off analysis for competing design and technology approaches. FIGS. 3-8 illustrate various reliability analyses, approaches, methodologies, and processes which may be implemented with embodiments of the invention. Other embodiments of the invention can incorporate some of all of these analyses with other reliability type analyses.

Reliability Task: Obtaining Subsystem Historical Failure Data. In one embodiment, a reliability task can include obtaining or collecting subsystem historical failure data. The evaluation of historical failure data can be a valuable means to understand the reliability performance of a product when it is applied. That knowledge can be used to improve the design to eliminate or reduce prior failure modes. For instance, a supplier can identify similar (based upon technology and application) products and capture failure events from warranty data and field complaints as available. The failure modes, root causes, and corrective actions can be documented for use in a failure mode and effects analysis (FMEA), similar to the process and chart 300 described in FIG. 3, to be performed later. Upon completion, an output or report can be generated and the data can be submitted to the customer for review and approval.

System/Subsystem Failure Mode and Effects Analysis (FMEA). In another embodiment, a reliability task can include obtaining or conducting a system/subsystem failure modes and effects analysis. FIG. 3 illustrates an example chart 300 for providing a failure mode and effects analysis (FMEA) in accordance with an embodiment of the invention. One purpose of a failure modes and effects analysis (FMEA) is to verify the performance of a design in the event of a system or subsystem failure. All failures should have known effects. For fault-tolerant systems, the item should continue to function with no, or specified known limitations. Systems with diagnostics should be able to identify and isolate the failure for rapid repair and minimum down time. As a minimum, the FMEA should be updated after any product design modifications. Upon completion, an output or report can be generated and the data can be submitted to the customer for review and approval.

In the embodiment shown in FIG. 3, data collected for a FMEA chart 300 can include, but is not limited to, potential failure modes, potential failure effects, a severity scale or measure, potential causes, an occurrence scale or measure, current controls, a detection scale or measure, actions recommended, responsibility, actions taken and result summary, status, and a risk priority number, scale, or score. In this example, data can be input to the chart 300 in a series of rows 302 with each of the columns 304 corresponding to some or all of the data types described above. Depending on the relative severity, occurrence, and detection of a particular item, a score or rating for each item can be generated.

An example process for performing a failure mode and effects analysis (FMEA) is as follows. In this example, analysis can be performed for some or all of the failure events at any given time for a product. In some embodiments, the analysis can be limited to a single failure event at any one time. In other embodiments, human error and non-specified input/output conditions are usually not considered in a functional FMEA. With reference to the example chart 300 in FIG. 3, the upper section 306 of the chart 300 is completed to identify the system, subsystem, and analyst/participants information and date. Document numbers and revisions can be tracked on the chart 302 for subsequent revision and modification.

Using design documentation for a product of interest, a supplier can identify some or all of the systems and/or subsystems for the product and break the product down for further analysis. Each system and/or subsystem can be identified in a respective row 302 on the chart 300 with corresponding failure modes and causes of each failure modes.

Identification of each of the failure modes and causes of each item can include key design, manufacturing, installation, operation, and maintenance processes in failure causes. Each of the failure modes and causes can be associated with an occurrence scale or measure to indicate the likelihood or probability of each failure mode. For example, an occurrence scale 308 or series of measures with corresponding likelihood thresholds are shown adjacent to the chart 300. In this example, occurrence measures can vary from 1 to 10, with 1 corresponding to an occurrence of an event once every 6-100 years and a probability of approximately less than 2 per billion; and 10 corresponding to an occurrence of an event more than once a day and a probability of approximately less than or equal to 30%. Other embodiments can include similar or different occurrence measures or scales.

Using a functional analysis for each of the failure modes and causes, the potential failure effects of each failure mode can be determined. In one example, the potential failure effects can include effects on external, output requirements and effects on internal requirements.

Next, a severity scale or measure can be associated with each system level effect. For example, a severity scale 310 or series of measures are shown adjacent to the chart 300. In this example, severity measures can vary from 1 to 10, with 1 corresponding to “a failure could be unnoticed and not affect the performance” and 10corresponding to “a failure could injure a customer or employee.” Other embodiments can include similar or different severity measures or scales.

Next, a detection scale or measure can be associated with each failure mode. For example, a detection scale or series of measures 312 are shown adjacent to the chart 300. In this example, detection measures can vary from 1 to 10, with 1 corresponding to “defect is obvious and can be kept from affecting the customer” and 10 corresponding to “defect caused by failure is not detectable.” Other embodiments can include similar or different detection measures or scales.

Based at least in part on the occurrence measure, severity measure, and detection measure for each failure mode, a risk priority number (RPN) or similar cumulative measure can be calculated. For instance, an example RPN can be a function of Likelihood of Occurrence×Severity×Detection Probability.

For each item and its associated failure modes, some or all of the above steps can be repeated as needed. When the data associated with the failure modes and effects have been input to the chart 300, some or all of the data can be sorted or otherwise organized as a function of descending RPN measures or another similar cumulative measure. The highest RPN measure represents the highest risk to the design of the product, and the lowest RPN measure represents the lowest risk to the design of the product.

Based at least in part on the data in the chart 300, one or more corrective actions for each failure mode can be developed. In general, the corrective actions can mitigate some or all of the risk associated with the failure mode and/or effects. In one embodiment, corrective actions can be determined for certain issues ranked above or meeting a certain risk threshold. For example, the issues with the highest RPN score and potential cost of failure impact can be evaluated to determine corrective actions.

Using some or all of the above steps, a failure mode and effects analysis (FMEA) can be conducted or performed for a particular product of interest. Upon completion, an output or report can be generated and the data can be submitted to the customer for review and approval.

Reliability Task: Obtaining an Application Analysis. In another embodiment, a reliability task can include obtaining or conducting an application analysis. In general, in this type of analysis, a supplier can verify whether a particular application of a product is compatible with and consistent with its design. In most instances, this type of analysis applies to commercial “off the shelf” catalog products and not to custom designed components and assemblies for products. In this manner, the misapplication of a product can be avoided. Misapplication of a product can lead to erratic performance, performance degradation and/or premature failure. Thus, a product that is selected for use in a particular application should be suitably designed to perform the intended function associated with the application.

An application analysis begins with a supplier's careful review of manufacturer data sheets and application notes, which should be completed before any use of the product. For any product that may be used outside of its original design boundaries, a validation plan can be developed and executed prior to use of the product. Upon completion, an output or report can be generated and the data can be submitted to the customer for review and approval.

Reliability Task: Obtaining an Environmental Analysis. In yet another embodiment, a reliability task can include obtaining or conducting an environmental analysis. Generally, in this type of analysis, a supplier can verify the design of a product down to its component level, and determine whether the product is compatible with the maximum specified environmental boundary conditions. A product functional specification can sometimes define some or all environmental boundary conditions which may present stresses on various components within a particular product. In one example, the environment a product may be exposed to is the external environment the product may be exposed to when the product is within a protective enclosure and/or cabinet. In another example, the environment can be an internally generated environment such as an environment affected by air conditioning, cooling air, heaters, and self generated heat.

For this type of analysis, a supplier can identify all components for a particular product. The supplier can compare the component manufacturer's specifications to one or more worst-case environmental application requirements. In some instances, external environmental boundary conditions can be altered due to the protection offered by the product as well as microenvironments that may be created internal to the product. Examples of these instances can include, but are not limited to, an enclosure that offers rain protection, or internal coolers that prevent excessive temperatures. In one embodiment, an environmental study can be conducted to identify some or all environmental conditions that will exist at all locations inside a product or associated system. Each component of the product or associated system can be evaluated to ensure that each component is designed to operate for the life of the product or associated system under those particular conditions. Incompatibility with the particular conditions or shortened life spans may be sought to be resolved at this stage. In addition, risk conditions and particular product components can be identified for inclusion in other types of tests, such as accelerated life testing and environmental qualification testing. Upon completion, an output or report can be generated and the data can be submitted to the customer for review and approval.

Reliability Task: Obtaining a Stress Analysis. In yet another embodiment, a reliability task can include obtaining or conducting a stress analysis. In general, for this type of testing, a determination whether an applied stress exceeds the maximum design capability strength. Typically, the greater the stress margin in a product, the greater the reliability and life of the part. In one example, this margin can be defined as the “derating.” In some instances, the cost, size, and efficiency of a product can be traded off to increase design margin.

For this type of analysis, a supplier can determine the operating stress of one or more product components in comparison to the rated strength of the components. The analysis result is the stress ratio. The stress ratio is the actual operating stress divided by the component strength rating or the specified stress limit. Upon completion, an output or report can be generated and the data can be submitted to the customer for review and approval.

One example stress analysis can evaluate some or all dominant application stresses for component strength. If component ratings for a particular stress are unavailable, then additional analyses may be required to determine the strength of the component. For electronic and electromechanical components, a review of some or all manufacturer data sheets for each component can be performed to determine strength. To determine the strength of mechanical components or systems, a finite element analysis can be performed. For example, typical stresses to be considered in an electrical-type product or system can include, but are not limited to, voltage, current, power, frequency, and load. In another example, typical stresses to be considered in a mechanical-type product or system can include, but are not limited to, pressure, acceleration, flow, vibration, force/load/weight, cycles, and temperatures or displacements. Risk conditions and product components can be further tested, for instance, in accelerated life testing and/or environmental qualification testing. Upon completion, an output or report can be generated and the data can be submitted to the customer for review and approval.

Reliability Task: Obtaining a Prediction of Component Failure Distributions. Typically, reliability predictions can play a vital role in the design of a product. The reliability, or the probability of a product meeting its intended function over its intended lifetime can be one functional characteristic of the product. In one embodiment, during a design phase of a product, the reliability of the product can be predicted based at least in part on the product components, materials, construction, and application. A designer can identify a measure of the reliability performance, identify failure rate drivers, and perform trade-off studies on various product configurations. In at least one embodiment, this process can yield a measure of the reliability with respect to the specified quantitative reliability and maintainability requirements. For example, one prediction of component failure distributions can be a failure rate prediction which includes a failure rate distribution, mean, and standard deviation. FIG. 4 illustrates a examples of several failure rate prediction methods.

In the embodiment shown in FIG. 4, the chart 400 includes a column of preferences 402 ranging from highest to lowest, and corresponding column of prediction methods 404. As indicated in the chart 400, the highest preference for prediction methods is a physics-based industry standard-type method 406. A relatively lower preference of methods is an empirical data or quantified confidence-type method 408. The lowest preference of methods is an expert opinion 41 0. In any embodiment, a component failure distribution and associated failure rate prediction for a product component should be based at least in part on the technology, materials, construction, operating stress, and environmental conditions. In one embodiment, the selected complexity of a prediction model for determining or modeling component failure distribution can be a function of the risk level defined in the product specification, model availability, and investment value for new model development.

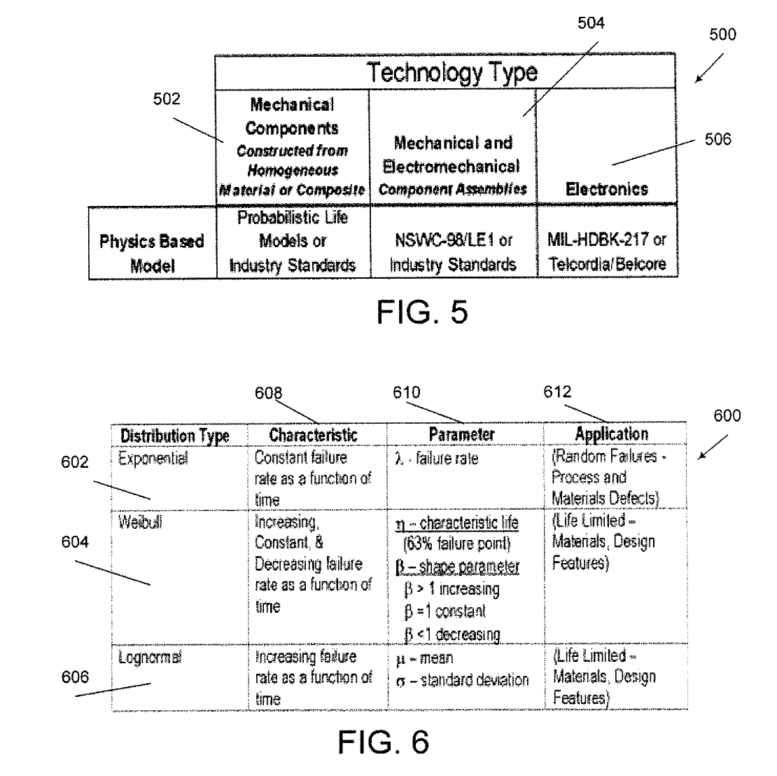

In one embodiment, using a physics-based industry standard-type method, such as 406, a transfer function can be used in an associated physics based failure rate model. The transfer function can be based at least in part on the technology, materials, construction, operating stress, and environmental conditions. An output from such a model can be used to determine the product failure distribution mean and standard deviation for a product component. Examples of typical model types by technology class are described in FIG. 5.

In FIG. 5, a chart 500 illustrates several example failure rate model types which can be used for a physics based model depending on the technology type. In this chart 500, at least three technology types are listed including, but not limited to, mechanical components 502, mechanical and electromechanical component assemblies 504, and electronics 506. Corresponding specifications for example failure rate models are illustrated for each technology type, for instance, probabilistic life models or industry standards can be utilized for mechanical components 502. In another instance, an NSWC-98/LE1 specification or industry standards can be utilized for mechanical and electromechanical component assemblies 504. In yet another instance, an MIL-HDBK-217 specification or Telecordia/BELCORE specification can be utilized for electronics 506.

By way of example, for mechanical components constructed from a single metallic, plastic, or other homogenous material or composite, failure rates can be predicted from physics based probabilistic life assessments. A complete probabilistic life model includes transfer functions for all dominant life limiting failure modes and the respective variable distribution parameters. Other probabilistic life methods used by the supplier can be submitted to the customer for review and approval.

In another example, an NSWC-98/LE1 specification can provide constant failure rate transfer functions for a suitable model for mechanical and electromechanical components as a function of at least some of the following: product or product component technology type, dominant stress variables, temperature, materials properties, and environmental stress conditions. Many failure rate transfer functions in the NSWC specification can define failures in terms of failures per cycle. These may, in some instances, need to be converted to failures per hour by determining the number of cycles per hour a particular product or product component will operate on average. This rate can then be multiplied by the result.

In yet another example, the MIL-HDBK-217 specification can provide constant failure rate transfer functions for electronic components as a function of at least some of the following: component technology type, construction, dominant stress variables, temperature, manufacturing quality, and environmental stress conditions. In some instances, the user can apply the part stress procedure method of this specification to make use of the full transfer function. Environmental conditions may need to be selected and the operating temperature at the component location may need to be determined from a thermal analysis. In some instances, Telecordia/BELCORE TR-332 specification can provide a similar set of models for electronic components but may provide a single assumed environmental condition, relatively fewer stress parameters, and smaller set of part technology models.

Referring back to FIG. 4, an empirical data method can be used to determine failure rate distributions and their associated mean and standard deviations using relatively high quality field or test data of a similar or equivalent product technology and application. Considerations for suitable field or test data can include, but are not limited to, the size of the sample population with respect to the total fleet population, fleet configuration variation, operating time or cycles, suspensions (units without failure) in addition to the failure data, proper identification of failure events, mission critical vs. non-critical failures, and unidentified failure mode associated with a failure event. Once data is suitably categorized, total population identified, exposure computed (hours or cycles), and suspensions can be included in the dataset, and a failure rate distribution can be identified through regression along with the distribution parameters.

Furthermore, an expert opinion may be used as a failure rate prediction method. When physics based models or empirical data with known confidence bounds are not available or determined to not be cost effective to develop, an expert opinion can be an effective tool to determine the failure rate of a component. The use of an expert opinion can define the failure distribution, mean, and standard deviation for a particular product or product component. For example, in some instances, the Delphi method of question selection can be used to achieve relatively accurate results.

After a suitable failure rate prediction method has been selected based on the technology type of the product or product component, the results of the prediction can be quantified, for instance, as a failure distribution for each component in the product. FIG. 6 illustrates several example failure distributions and their associated characteristics, parameters, and applications. As shown in FIG. 6, the chart 600 illustrates three types of distribution types including Exponential 602, Weibull 604, and Lognormal 606. Corresponding columns describing associated characteristics 608, parameters 610, and applications 612 are adjacent to each example failure distribution.

When documenting the results of a failure rate prediction some or all assumptions and methods can be documented. Risk conditions and product components can be further tested, for instance, in accelerated life testing and/or environmental qualification testing. Upon completion, an output or report can be generated and the data can be submitted to the customer for review and approval.

Reliability Task: Obtaining a Mean Time to Repair. In yet another embodiment, a reliability task can include obtaining or determining a mean time to repair. In general, the mean time to repair is the mean time required to replace a defective product or product component. A suitable design process can include design for maintainability to minimize the down time needed to repair a failure. The time to be accounted for should be carefully defined since there are many tasks that are typically overlooked. As an example, the repair time can include, but is not limited to, resource and equipment availability, time to set up trouble shooting instruments, time to isolate the failure to a replaceable part, time to acquire a spare part, access and/or cool down time, remove and replace time, repair/replace parts from secondary damage, and verification test time. During the design analysis phase, the mean time to repair each product or product component can be calculated and documented. Suppliers and sub-suppliers may need to consult the applicable customer design teams for accurate data, such as access and/or cool down, remove and replace times, etc. The results of the analysis can be used to identity maintainability improvements to reduce the time to repair the product and/or product components. The product level mean time to repair can be calculated as a function of the individual component repair times weighted by the failure rate. When documenting the results of a mean time to repair prediction, some or all assumptions can be documented. Upon completion, an output or report can be generated and the data can be submitted to the customer for review and approval.

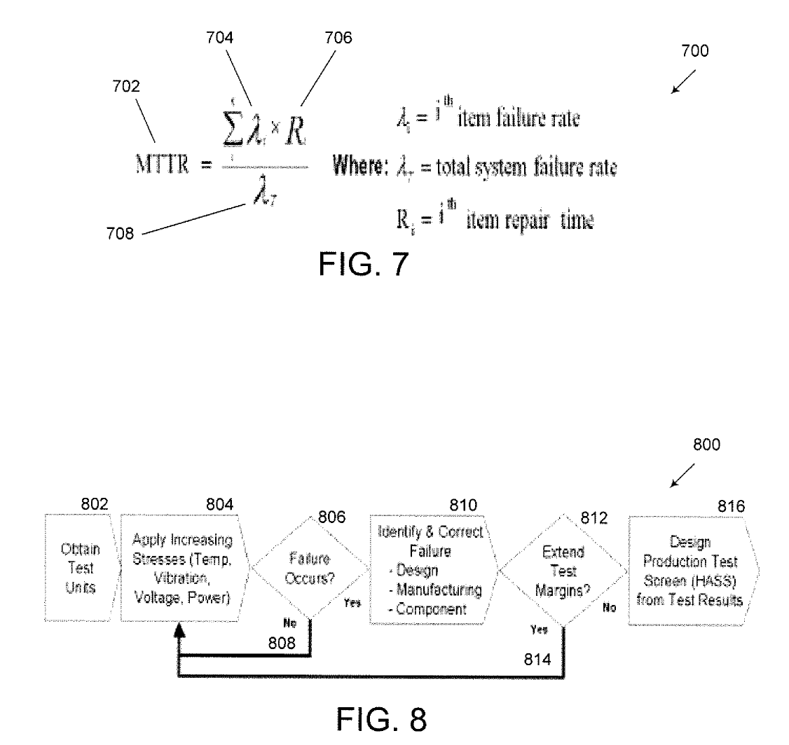

FIG. 7 illustrates an example equation 700 for determining a mean time to repair. In this example equation, the mean time to repair (MTTR) 702 is a function of the item failure rate 704 times the item repair time 706, divided by the total system failure rate 708. This example equation can be applicable to determining a constant failure rate for a product and/or a series of product components. In other embodiments, other equations, functions, or formulas can be used for determining or approximating a mean time to repair.

Reliability Task: Obtaining a Mean Time to Maintain. In yet another embodiment, a reliability task can include obtaining or determining a mean time to maintain. In general, preventative maintenance is an interval based maintenance procedure which can be based at least in part on actual product lifing data and “physics of failure” type methodologies. The design process can include design for maintainability to minimize the total scheduled maintenance time needed to prevent premature failure of a product or product components. The maintenance tasks and interval periods can be designed to prevent a product or product component from reaching its end of life point and to maximize its reliability. The mean time to maintain is the mean time required to inspect, calibrate, refurbish, or overhaul a component at a planned interval. This interval-based maintenance can usually be implemented during a regularly scheduled system outage and can be a proactive approach to extending the life of a product. The maintenance time to be accounted for can be carefully defined since there are many tasks that can be typically overlooked. As an example, the time to maintain can include: access and/or cool down time, time to set up test instruments, time to refurbish, remove and replace time, verification test time, and time to restart the unit. During the design analysis phase, the mean time to maintain each component can be calculated and documented for use in system level reliability, availability, and maintainability assessments. The maintenance time and intervals can be optimized to minimize the failure rate and reduce the life cycle cost. When documenting the results of a mean time to maintain prediction, some or all assumptions can be documented. Upon completion, an output or report can be generated and the data can be submitted to the customer for review and approval.

Reliability Task: Obtaining Reliability Model. In yet another embodiment, a reliability task can include obtaining or determining a reliability model. In general, a reliability model, such as a system reliability model, can represent a mathematical transfer function of some or all of the functional interdependencies for a product or product component. The transfer function and its representative functional interdependencies can provide a framework for developing quantitative product level reliability estimates. A reliability block diagram (RBD) is a example graphical representation of a reliability model. Such a diagram can define a product or system, and contain some or all subsystems and product components that can be affected in a system, product, or product component failure. In one embodiment, some or all failure modes and effects can be represented in the RBD as defined in the FMEA. Functional characteristics of the product or system, particularly series and redundant natures, can be modeled in order to quantify their effects. Once the model is populated with appropriate failure rates, repair rates, and maintenance intervals, a RBD can allow for evaluations of the product or system design and of the significance of individual subsystems and components on the total system reliability, availability, and maintainability (RAM) performance.

In one embodiment, a reliability model can be used to determine the mission failure rate of a product, product component, system or subsystem with redundancy and/or fault tolerance. Furthermore, a reliability model can be used to determine product or system availability of products, product components, systems or subsystems with scheduled maintenance requirements. In addition, a reliability model can be used to enable trade-off assessments for competing design and technology approaches. Moreover, a reliability model can be used to determine availability or failure rate of products, product components, systems or subsystems with failure rates that vary as a function of time.

In another embodiment, various data can be used for a reliability model. For example, suitable data for a reliability model can include, but is not limited to, definition of effect of component/system failure effects from the FMEA (this information can identify fault tolerance, redundancy, or series model configuration, of the product or system); for redundant components, the type of repair that is required, whether on-line (while the system is operational), or off line (the system needs to be shut down to perform the repair); failure distributions and associated parameters; the mean time to repair for each of the product components; and the preventative scheduled maintenance interval and time to perform for each component.

In one embodiment, a suitable tool for building a reliability model is ReliaSoft BlockSim™ or a similar software-based application program. In particular, this example tool can permit a user to manipulate a graphical user interface to allow the creation of a transfer function from a reliability block diagram. Other tools and data can be submitted to the customer for review and approval.

The results of a reliability model, such as a reliability simulation model, can output a set of predicted reliability parameters. These parameters can include, but are not limited to, availability, failure rate, reliability (mean availability without preventative maintenance and inspection), corrective maintenance down time, and preventative maintenance down time. The reliability model results can be used to determine one or more product or system-limiting components. Upon completion, an output or report can be generated and the data can be submitted to the customer for review and approval.

Reliability Task: Designing for Reliability. In yet another embodiment, a reliability task can include designing for reliability. In general, some or all of the computed reliability and maintainability predictions can be compared to product specifications or other predefined customer or vendor requirements. If the design specifications or other requirements are not met, design changes can be developed to achieve the specifications or requirements. Trade-off assessments can be part of the overall design process to optimize some or all design specifications and requirements.

In one embodiment, some or all of the following steps can be performed to identify design improvements: (1) Review action items from design analysis and update failure rates and maintenance times as necessary; (2) Identify highest failure rate and greatest forced outage time components (drivers); (3) For the driving items, develop product, product component, system, or subsystem configuration design changes that may be incorporated to improve performance; (4) For the driving items identify product or product component design (stress/strength) or technology changes that may be incorporated to improve performance; and (5) For the driving items optimize the accuracy of the failure rates and maintenance times.

If any improvements or design changes are implemented, the reliability task can be iteratively performed as needed. That is, a new simulation and computation for a reliability block diagram can be implemented with some or all of the design improvements. This process can be implemented as needed until some or all of the design specifications or requirements are achieved or no further improvement can be made. Upon completion, an output or report can be generated and the data can be submitted to the customer for review and approval.

Reliability Task: Performing Reliability Testing. In general, reliability testing is a method by which uncertainties in the design analyses can be addressed. Some or all technical risks identified by the design analysis phase can be applied in the development of the testing program. Actual demonstration of a product's or product component's quantified reliability can be typically cost prohibitive due to the relatively small production volume and high system reliabilities.

In one embodiment, one type of reliability testing that can be performed is highly accelerated life testing (HALT). One purpose of highly accelerated life testing is to identify design weaknesses and/or manufacturing/application problems by applying increasing levels of environmental, electrical, and mechanical stresses to the product or product component in order to precipitate failures. Once a failure is detected, root cause analysis can be performed and one or more corrective actions can be applied to eliminate or otherwise minimize the failure mode, and therefore, improve the overall product or product component reliability. This type of test-to-failure process can be continually performed until the material limits of the product or product component are reached and no further design improvements can be realized. Typically, the HALT test methodology can define upper and lower operating limits (UOL, LOL) and upper and lower destructive limits (UDL, LDL) of a product or product component. However, in some instances, HALT testing may be limited in computing the reliability of a product or product component because the acceleration factors used by this type of test may be non-linear. In most instances, HALT testing can be one of the more cost effective reliability growth methods due to ease of application. This test technique can optimally be applied during early engineering development.

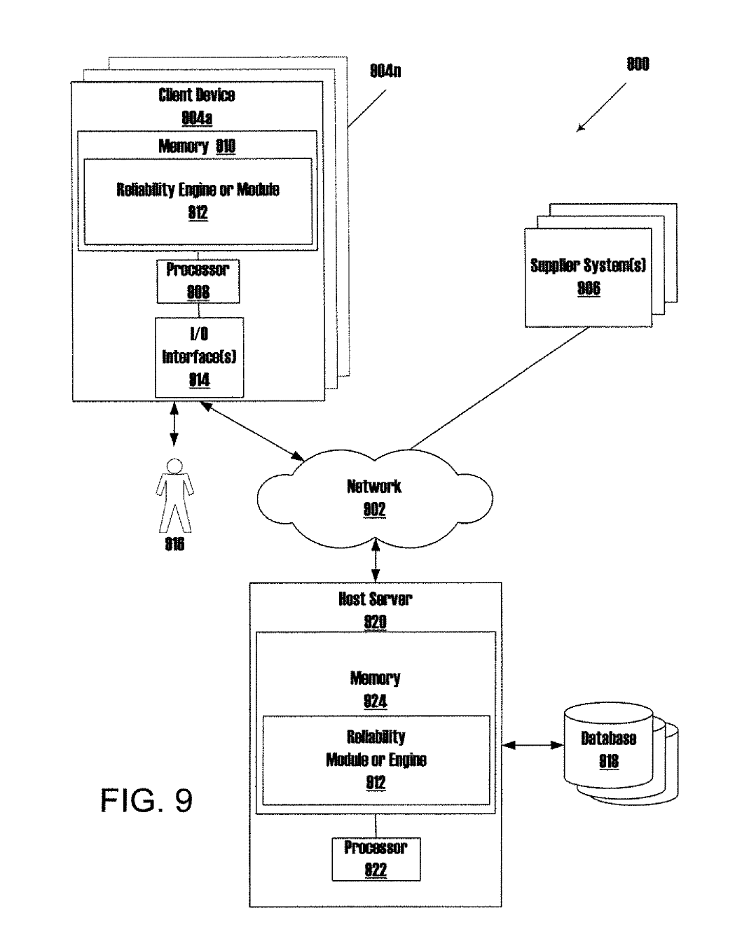

An example process flow for a HALT test is shown in FIG. 8. In FIG. 8, a HALT process 800 begins at block 802. In block 802, test units are obtained.

Block 802 is followed by block 804, in which increasing stresses are applied, such as temperature, vibration, voltage, and power.

Block 804 is followed by decision block 806, in which a determination is made whether a failure occurs. If no failure occurs, then the return “NO” branch 808 is followed to block 802.

Referring back to decision block 806, if a failure occurs, then the “YES” branch is followed to block 810. At block 810, the failure is identified and corrected, including the analysis of the design, manufacturing, and component.

Block 810 is followed by decision block 812, in which a determination is made whether to extend test margins. If test margins are to be extended, the return “YES” branch 814 is followed back to block 804.

Referring back to decision block 812, if the test margins are not to be extended, the “NO” branch is followed to block 816. At block 816, the production test screen (HASS) is designed from the test results. The method 800 ends at block 816.

In other embodiments, an example process flow for a HALT test can have fewer or greater numbers of steps, and the steps may be performed in an alternative order.

An example process flow of how to design a HALT test is described as follows. In a first step, a functional test to be completed at each stress step level is defined. A determination of the number of actuations/excitations of the component at each stress step is also determined. Numbers of actuations/excitations should be of a sample size sufficient to assure repeatability of the results.

In a next step, a failure detection system to continuously monitor the proper operation of the component/system during the HALT test is defined.

In a following step, the type of stresses to apply are identified by identifying the application conditions (temperature, vibration, electrical and mechanical stress, etc.) that may result in premature failure due to exceeding the strength of the component.

In a subsequent step, a HALT step stress test framework is created by identifying the starting stress level (starting temperature, vibration, etc.), step size interval and step time interval.

In another step, the step stress starting levels are determined based at least in part on the component manufacturers published design data. As a guideline, for upper design limits use the manufacturers upper design limit minus a 10% margin. For lower limits, use the manufacturers lower design limit plus a 10% margin.

In a following step, the step size interval is determined based at least in part on the resolution required and the time available for testing.

In a subsequent step, the step dwell time is determined based at least in part on the functional test definition and time required for actuation/excitation.

In an additional step, the HALT test framework is created for any additional condition that exists, which may cause the application stress to approach or exceed the component strength.

In other embodiments, an example process flow of how to design a HALT test can have fewer or greater numbers of steps, and the steps may be performed in an alternative order.

In some instances, HALT testing can be performed to validate a design analysis when a concern exists whether specific application stress or stresses applied to a critical product component approaches or exceeds the strength of the component. Once this concern or others have been identified, a HALT test plan can be designed to help determine the actual operating and destructive limits (upper and lower). Upon completion, an output or report, such as a HALT test plan, can be generated and the data can be submitted to the customer for review and approval.

In other instances, HALT tests can be designed to apply multiple stresses to a product component. A design of experiments-type methodology can be used to assist with this type of test design. Upon completion, an output or report, such as a HALT test plan, can be generated and the data can be submitted to the customer for review and approval.

In one embodiment, an output or report can include the recorded results from an appropriate scorecard or checklist. The output or report can also include some or all of the following: dates of testing, listing of test equipment used, listing of test units, configurations, and serial numbers, include pictures and/or video of test units, equipment and configurations, functional test procedures used to verify successful performance, any test anomalies, failure analysis and corrective actions taken, and summary of LOL, UOL, LDL, and UDL for each stressor tested.

In another embodiment, another type of reliability testing that can be performed is environmental testing. For example, one type of environmental testing is a product validation test. In general, environmental testing can be performed in accordance with the requirements defined in a product specification, such as a customer provided product functional specification. Relatively successful performance of a product or product component under normal and extreme environmental conditions can be critical to assuring the reliability of the product or product component. Environmental qualification test conditions can include the expected worst-case application conditions. In some instances, the performance can be quantified based at least in part on measurement of parameters rather than pass/fail testing. Environmental parameters can include, but are not limited to: temperature, random vibration, sine vibration, mechanical shock, humidity, salt spray, and rain.

In some instances, laboratory test facilities can be limited in their abilities to duplicate naturally occurring environmental conditions. Therefore, caution may be exercised when specifying test criteria and conditions. The equipment specifications, industry standards, military standards, and specific application information can be used to define the specific definitions of “failure” and “critical functions” for the tests. The environmental test plan can be developed in accordance with applicable industry and military standards, such as IEC60068 and MIL-STD-810. Prior to initiation of the test, an output or report, such as a test plan, can be generated and submitted to the customer for review and approval prior to the initiation of the test. Upon completion of the approved test, an output or report, such as a test report, can be generated and the data can be submitted to the customer for review and approval. The test report can include, for example, a description of the equipment under test, test set-up, test conditions, a detailed results summary including any failure and corrective action information, any deviations to the test procedures and a deviation justification summary.

In another embodiment, another type of reliability testing that can be performed is an electromagnetic interference test. One purpose of electromagnetic interference (EMI) testing is to ensure electrical and electronics equipment can tolerate specified electromagnetic environments without failure to perform critical functions. Reliable operation can be demonstrated under specified and expected electromagnetic conditions. The specific definitions of “failure” and “critical functions” for such tests can be defined by a product specification or requirement. In some instances, EMI testing can apply to all products or product components that may be interfered with in the presence of high radiated or conducted electromagnetic interference.

In one embodiment, an EMI test plan can be developed in accordance with an appropriate industry standard, such as IEC 61000-6-5 or IEC 61000-4-1. The standard can be selected to meet the applicatior/customer requirements. Prior to initiation of the test, an output or report, such as a test plan, can be generated and submitted to the customer for review and approval prior to the initiation of the test. Upon completion of the approved test, an output or report, such as a test report, can be generated and the data can be submitted to the customer for review and approval. The test report can include, for example, a description of the equipment under test, test set-up, test conditions, a detailed results summary including any failure and corrective action information, any deviations to the test procedures and a deviation justification summary, and any documentation demonstrating compliance with appropriate standards.

FIG. 9 illustrates an example system 900 for analyzing reliability of a product provided by a supplier according to one embodiment of the invention. In one example, the system 900 can implement the method 100 shown and described with respect to FIG. 1. In another example, the system 900 can implement some or all of the processes, techniques, and methodologies described with respect to FIGS. 2-8.

The system 900 is shown with a communications network 902 in communication with at least one client device 904a. Any number of other client devices 904n can also be in communication with the network 902. The network 902 is also shown in communication with at least one supplier system 906. In this embodiment, at least one of the client devices 904a-n can be associated with a customer, and the supplier system 906 can be associated with a supplier providing a product to the customer.

The communications network 902 shown in FIG. 9 can be a wireless communications network capable of transmitting both voice and data signals, including image data signals or multimedia signals. Other types of communications networks can be used in accordance with various embodiments of the invention.

Each client device 904a-n can be a computer or processor-based device capable of communicating with the communications network 902 via a signal, such as a wireless frequency signal or a direct wired communication signal. Each client device, such as 904a, can include a processor 908 and a computer-readable medium, such as a random access memory (RAM) 910, coupled to the processor 908. The processor 908 can execute computer-executable program instructions stored in memory 910. Computer executable program instructions stored in memory 910 can include a reliability module application program, or reliability engine or module 912. The reliability engine or module 912 can be adapted to implement a method for analyzing reliability of a product provided by a supplier. In addition, a reliability engine or module 912 can be adapted to receive one or more signals from one or more customers and suppliers. Other examples of functionality and aspects of embodiments of a reliability engine or module 912 are described below.

One embodiment of a reliability engine or module can include a main application program process with multiple threads. Another embodiment of a reliability engine or module can include different functional modules. An example of one programming thread or functional module can be a module for communicating with a customer. Another programming thread or module can be a module for communicating with a supplier. Yet another programming thread or module can provide communications and exchange of data between a customer and a supplier. One other programming thread or module can provide database management functionality, including storing, searching, and retrieving data, information, or data records from a combination of databases, data storage devices, and one or more associated servers.

A supplier system 906 can be, for example, similar to a client device 904a-n. In this example, the supplier system 906 can be adapted to receive information from a client device 904a-n via the network 902. In one embodiment, the supplier system 906 can provide information associated with product reliability to a client device 904a-n via the network.

Suitable processors may comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media include, but are not limited to, an electronic, optical magnetic, or other storage or transmission device capable of providing a processor, such as the processor 906, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Client devices 904a-n may also comprise a number of external or internal devices such as a mouse, a CD-ROM, DVD, a keyboard, a display, or other input or output devices. As shown in FIG. 9, a client device such as 904a can be in communication with an output device via an I/O interface, such as 914. Examples of client devices 904a-n are personal computers, mobile computers, handheld portable computers, digital assistants, personal digital assistants, cellular phones, mobile phones, smart phones, pagers, digital tablets, desktop computers, laptop computers, Internet appliances, and other processor-based devices. In general, a client device, such as 904a, may be any type of processor-based platform that is connected to a network, such as 902, and that interacts with one or more application programs. Client devices 904a-n may operate on any operating system capable of supporting a browser or browser-enabled application, such as Microsoft® Windows® or Linux. The client devices 904a-n shown include, for example, personal computers executing a browser application program such as Microsoft Corporation's Internet Explorer™, Netscape Communication Corporation's Netscape Navigator™, and Apple Computer, Inc.'s Safari™.

In one embodiment, suitable client devices can be standard desktop personal computers with Intel x86 processor architecture, operating a LINUX operating system, and programmed using a Java language.

A user, such as 916, can interact with a client device, such as 904a, via an input device (not shown) such as a keyboard or a mouse. For example, a user can input information, such as specification data associated with a product, other product-related information, or information associated with reliability, via the client device 904a. In another example, a user can input product or reliability-related information via the client device 904a by keying text via a keyboard or inputting a command via a mouse.

Memory, such as 910 in FIG. 9 and described above, or another data storage device, such as 918 described below, can store information associated with a product and product reliability for subsequent retrieval. In this manner, the system 900 can store product specification and reliability information in memory 910 associated with a client device, such as 904a or a desktop computer, or a database 918 in communication with a client device 904a or a desktop computer, and a network, such as 902.

The memory 910 and database 918 can be in communication with other databases, such as a centralized database, or other types of data storage devices. When needed, data stored in the memory 910 or database 918 may be transmitted to a centralized database capable of receiving data, information, or data records from more than one database or other data storage devices.

The system 900 can display product specification and reliability information via an output device associated with a client device. In one embodiment, product specification and reliability information can be displayed on an output device, such as a display, associated with a remotely located client device, such as 904a. Suitable types of output devices can include, but are not limited to, private-type displays, public-type displays, plasma displays, LCD displays, touch screen devices, and projector displays on cinema-type screens.

The system 900 can also include a server 920 in communication with the network 902. In one embodiment, the server 920 can be in communication with a public switched telephone network. Similar to the client devices 904a-n, the server device 920 shown comprises a processor 922 coupled to a computer-readable memory 924. In the embodiment shown, a reliability module 912 or engine can be stored in memory 924 associated with the server 920. The server device 920 can be in communication with a database, such as 918, or other data storage device. The database 918 can receive and store data from the server 920, or from a client device, such as 904a, via the network 902. Data stored in the database 918 can be retrieved by the server 920 or client devices 904a-n as needed.

The server 920 can transmit and receive information to and from multiple sources via the network 902, including a client device such as 904a, and a database such as 918 or other data storage device.

Server device 920, depicted as a single computer system, may be implemented as a network of computer processors. Examples of suitable server device 920 are servers, mainframe computers, networked computers, a processor-based device, and similar types of systems and devices. Client processor 906 and the server processor 922 can be any of a number of computer processors, such as processors from Intel Corporation of Santa Clara, Calif. and Motorola Corporation of Schaumburg, Ill. The computational tasks associated with rendering a graphical image could be performed on the server device(s) and/or some or all of the client device(s).

Many modifications and other embodiments of the inventions set forth herein will come to mind to one skilled in the art to which these inventions pertain having the benefit of the teachings presented in the foregoing descriptions and the associated drawings. Thus, it will be appreciated by those of ordinary skill in the art that the invention may be embodied in many forms and should not be limited to the embodiments described above. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method for analyzing reliability associated with a product provided by a supplier, the method comprising:
providing a supplier a specification for a product, wherein the specification is based at least in part on an amount of risk to be associated with the product;
requesting the supplier to perform at least one task to analyze reliability associated with the product in accordance with the specification;
obtaining an output associated with the reliability from the supplier;
comparing the output to the specification for the product; and
based at least in part on the comparison, approving or disapproving of the product.

2. The method of claim 1, wherein the product comprises at least one of the following: a sub-product, a component, a sub-system, or a system.

3. The method of claim 1, wherein the at least one task comprises at least one of the following: obtaining historical failure data associated with one or more similar products; obtaining effects data associated with one or more predicted failures of the product; obtaining application analysis data associated with the product; obtaining environmental boundary conditions associated with the product; obtaining stress analysis data associated with the product; obtaining at least one failure rate prediction associated with the product; obtaining mean time to repair data associated with the product; obtaining mean time to maintain data associated with the product; or obtaining a reliability model for predicting a reliability estimate associated with the product.

4. The method of claim 1, wherein the output comprises at least one of the following: a report, an analysis, a summary, or a quantitative value.

5. The method of claim 1, wherein the specification comprises at least one of the following: a product functional specification, a physical characteristic, a functional characteristic, an electrical property, a mechanical property, a chemical property, an electromechanical property, an ornamental feature, a dimension, or any product feature which can be detected or measured by a customer.

6. A method for analyzing reliability associated with a product, the method comprising:
receiving a specification associated with a product, wherein the specification is based at least in part on an amount of risk to be associated with the product;
performing at least one task to analyze reliability associated with the product to a customer in accordance with at least a portion of the specification;
providing an output associated with the reliability to the customer; and
based at least in part on a comparison of the output to a portion of the specification associated with the product, receiving an approval or disapproval of the product from the customer.

7. The method of claim 6, wherein the product comprises at least one of the following: a sub-product, a component, a sub-system, or a system.

8. The method of claim 6, wherein the at least one task comprises at least one of the following: obtaining historical failure data associated with one or more similar products; obtaining effects data associated with one or more predicted failures of the product; obtaining application analysis data associated with the product; obtaining environmental boundary conditions associated with the product; obtaining stress analysis data associated with the product; obtaining at least one failure rate prediction associated with the product; obtaining mean time to repair data associated with the product; obtaining mean time to maintain data associated with the product; or obtaining a reliability model for predicting a reliability estimate associated with the product.

9. The method of claim 6, wherein the output comprises at least one of the following: a report, an analysis, a summary, or a quantitative value.

10. The method of claim 6, wherein the specification comprises at least one of the following: a product functional specification, a physical characteristic, a functional characteristic, an electrical property, a mechanical property, a chemical property, an electromechanical property, an ornamental feature, a dimension, or any product feature which can be detected or measured by a customer.

11. A system for analyzing reliability of a product provided by a supplier, the system comprising:
a reliability module adapted to:
provide a supplier a specification for a product, wherein the specification is based at least in part on an amount of risk to be associated with the product;
request the supplier to perform at least one task to analyze reliability associated with the product in accordance with the specification;
obtain an output associated with the reliability from the supplier;
compare the output to the specification for the product; and
based at least in part on the comparison, approve or disapprove of the product.

12. The system of claim 11, further comprising:
a memory device adapted to store information associated with product reliability.

13. The system of claim 11, further comprising:
an output device adapted to display product specification and reliability information.

14. The system of claim 11, further comprising:
a server adapted to communicate information associated with product reliability to a network.

15. The system of claim 11, wherein the reliability module is further adapted to communicate with at least one supplier system via a network.

16. A system for analyzing reliability associated with a product, the system comprising:
a reliability module adapted to:
receive a specification associated with a product, wherein the specification is based at least in part on an amount of risk to be associated with the product;
facilitate performing at least one task to analyze reliability associated with the product to a customer in accordance with at least a portion of the specification;
providing an output associated with the reliability to the customer; and
based at least in part on a comparison of the output to a portion of the specification associated with the product, receive an approval or disapproval of the product from the customer.

17. The system of claim 16, further comprising:
a memory device adapted to store information associated with product reliability.

18. The system of claim 16, further comprising:
an output device adapted to display product specification and reliability information.

19. The system of claim 16, further comprising:
a server adapted to communicate information associated with product reliability to a network.

20. The system of claim 16, wherein the reliability module is further adapted to communicate with at least one supplier system via a network.
